(19) United States
(12) Patent Application Publication
(10) Pub. No.: US 2006/0255584 A1
(43) Pub. Date: Nov. 16, 2006

(54) Clipboard with sliding tray

(76) Inventor: Yihwu Han, Naperville, IL (US)

Correspondence Address: Yihwu Han, 816 Burgess Hill Rd., Naperville, IL, 60565, US

(21) Appl. No.: 11/130,488

(22) Filed: May 16, 2005

(51) Int. Cl. B42D 7/00

(52) U.S. Cl. 281/45

(57) ABSTRACT

The invention is a clipboard apparatus comprising a thin tray that can be slid out easily when needed, otherwise closeted. The tray can hold a few pages of paper kept for the privacy of the information or for creating a positive effect when showing it. When the tray is closed, the clipboard looks just like a conventional one. The invention is easy to use and handy to take around.

### BACKGROUND OF THE INVENTION

1. Field of the Invention

This invention relates to a clipboard with an additional function of containing a tray to be slid out easily when needed, beyond providing a flat hard surface to write upon and a clip securing a pad of paper visible to people near-by. The paper held in the tray is unknown to the people near-by, except to the user of the clipboard who has put the paper in and will decide whether to share the held paper and when to share it. The present invention is designed to suit the needs of physicians who need a handy clipboard that can be toted around easily with a professional appearance, while protecting medical privacy of their patients.

2. Description of Related Art

Clipboards are used widely in various trades from repairpersons visiting clients' sites, inventory keepers, and restaurant workers, to professional offices like physicians who see patients in different clinical rooms or hospital rooms. The basic function of a clipboard, as illustrated in FIG. 1, has a flat surface that is flat to write on it when the user carrying the clipboard from one place to another, and a clip on the board that holds a deck of paper or documents.

For those various applications, there have been plenty inventions to suit different needs, as cited in the field of search. For instance, when one repairman dispersed to a client site, a clipboard may include a container, like a box. References 3, 4 and 5 all use this kind of containers.

FIG. 3 illustrates an example of the container found in reference 3. The containers are designed to keep paper from adverse environments for a trade person in the field and are usually opened from one side, and hinged on the other, as shown in FIG. 3. Even though these clipboards have their own merits in their applications for quite a while, we rarely see medical professionals like physicians carrying these clipboards when visiting their patients in clinical rooms or on hospital beds. These doctors do need to carry items in their pockets and write from time to time, but the bulky-container clipboards for a workmen's use may not fit their tastes and preference. They prefer something handy with a professional appearance, while satisfying the recent patient privacy act to protect the medical privacy of a patient from one another.

Reference 1 is a sandwich plastic clipboard with two planar surfaces that allow insertion one or few pages of paper used as reference material. It presents certain professionalism to medical professions but it can not used to carry private information satisfying the current private patient act, since the plastic is transparent. Neither can the paper be changed relatively easy.

In the meantime, to promote their products or services, advertising companies may use clipboards to print certain product information, like pharmaceutical medicine on the writing boards and/or the clips of clipboards; and to provide the clipboards as promotional products to physicians. FIG. 2 is an example of this kind of clipboard. The advertising companies also desire to have certain information to be printed but replaceable later. Holding a few printed pages in a small thin-tray below the writing board will satisfy an advertising company's need to promote their products of desire, and create an impression to their customers. To an end user of the clipboard, say a physician or a nurse, who can use the tray to hold certain private information, the user will find the new clipboard useful and practical. In other words, the promoter uses the sliding tray to keep certain exchangeable information of a product to be promoted to achieve a special impression to their customers, who in turn, use the sliding tray to keep private information for their business, such as medical private information of patients.

### SUMMARY OF THE INVENTION

The invention is, as shown in FIGS. 4-7, designed for physicians or other medical professionals who write and hold a few documents from place to place. In the meantime, they need to hold certain private information not shareable with all their customers. And they are working in a covered environment like an office or a hospital, unlike a repairperson in a field. More importantly, they need to present an image of professionalism and confidence, so far existing clipboards have not been able to provide.

### BRIEF DESCRIPTION OF THE DRAWINGS

FIG. 1: A Conventional Clipboard

FIG. 2: A Clipboard with printing as a promotional product

FIG. 3: An example of Clipboard with a box container

FIG. 4: Clipboard with Sliding Tray

FIG. 4.1: Clipboard with sliding tray

FIG. 4.2: Clipboard with sliding tray holding paper

FIG. 4.3: Clipboard held straight to the floor. The paper is secured by the tray and a paper holder on the tray.

FIG. 4.4: Clipboard with the tray pointed to the floor. This shows that the paper is held securely in the tray.

FIG. 5: Side Views of Clipboard with Sliding Tray (open wide and from different angles)

FIG. 5.1: Right Side View of Clipboard with sliding thin tray. The picture is taken from the tray opening side.

FIG. 5.2: Another side view of the clipboard, with the picture taken from the other side of tray's opening.

FIG. 5.3: Back side view of the clipboard, view from the tray opening side.

FIG. 5.4: Back side view of the clipboard, view from the other side of tray opening.

When the tray is closed, one can hardly notice the difference between the board and any other conventional board. FIG. 1, as a matter of fact, is the top view of a clipboard with a thin tray, with it closed. Back views of the clipboard with a thin tray, FIGS. 5.3 & 5.4 show the same point.

FIGS. 6 & 7 are to show the construction of the clipboard.

FIG. 6: Back views of different component of the board & top view of Tray Board

FIG. 6.1: Back View of the Clipboard. It shows the components of the clipboard, consisting of Clip, Primary Board, Top Track Strip, Tray Board, and Bottom Track Strip. Then the back of the Primary Board and a Track Strip are shown to illustrate the assembly.

FIG. 6.2: Back View of the Primary Board and the Bottom Track Strip.

This is to show their construction and assembly.

FIG. 6.3: Back View of the Tray Board. It shows the track, locks, and indentation.

FIG. 6.4: Front View of the Tray Board. It shows the tray edges, the tray, locks, and a paper holder.

FIG. 7: Figures illustrate the locking scheme and the tracking (slide the Tray Board out) scheme

FIG. 7.1: Locking Scheme Illustration. This figure amplifies the lock of the tray, and the “lockee” of a Track Strip. That is the piece working with the lock to lock the Tray Board.

FIG. 7.2: Side View of Tray Board and Track Strips. This figure is to illustrate the interactions between the Tray Board and Track Strips, when the tray is pulled out.

### DETAILED DESCRIPTION OF THE PREFERRED EMBODIMENTS

The invention is a clipboard apparatus comprising a thin tray that can be slid out easily when needed, otherwise locked, and that holds a few pages of paper kept for the privacy of the information or for creating a positive effect when showing it.

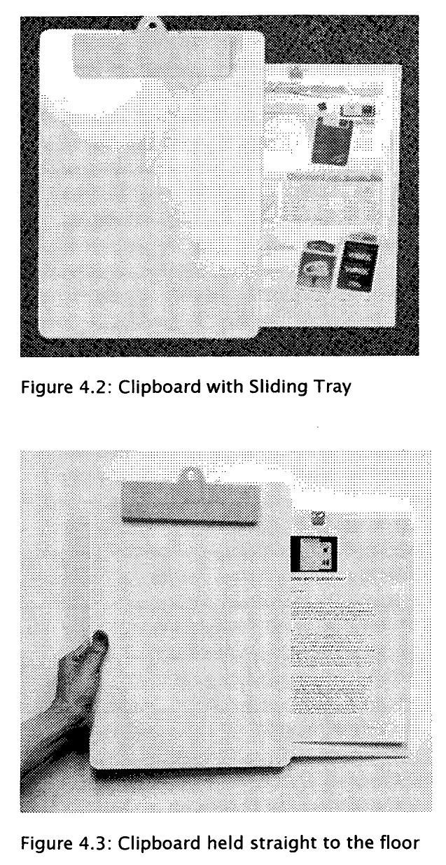

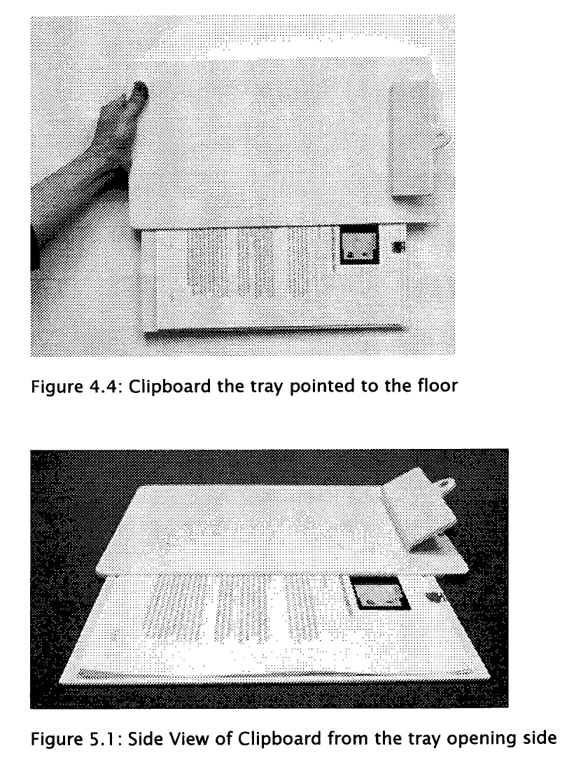

FIGS. 4.1 show the clipboard with a sliding tray half open, without paper in the tray. In FIG. 4.2, there is one page of paper inserted in the tray. At the center of the tray, a metal holder keeps paper in the tray without falling out when the clipboard is held in all different angles, demonstrated in FIGS. 4.3 & 4.4 as well. In these figures, the clipboard is held straight to the floor or even with the tray pointed to the floor, while holding paper securely.

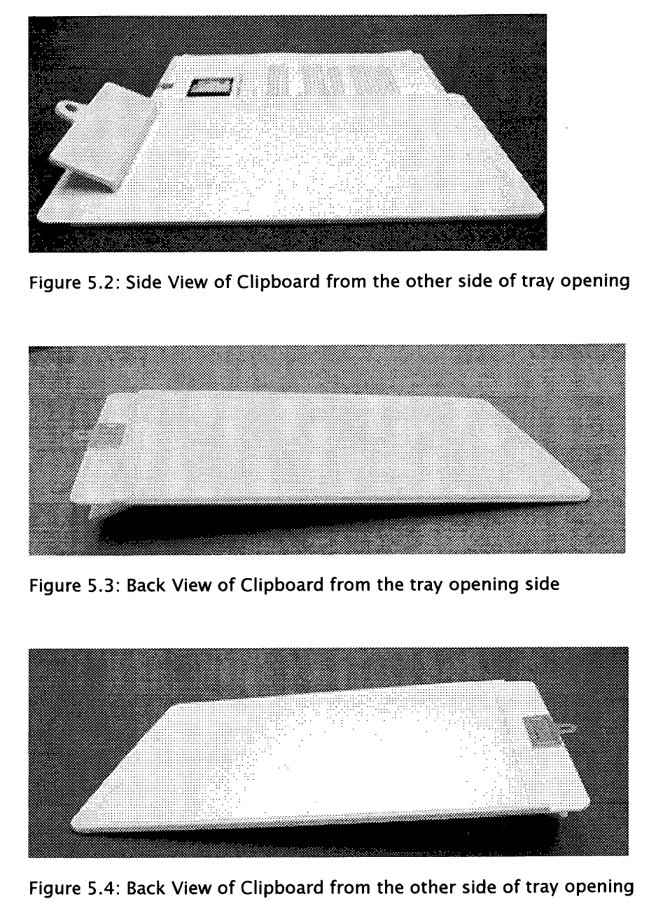

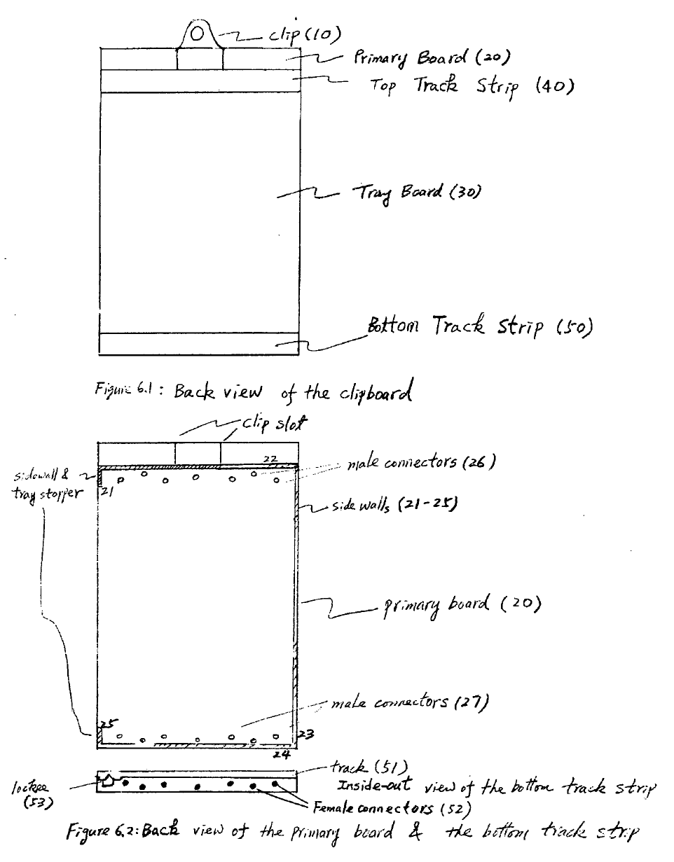

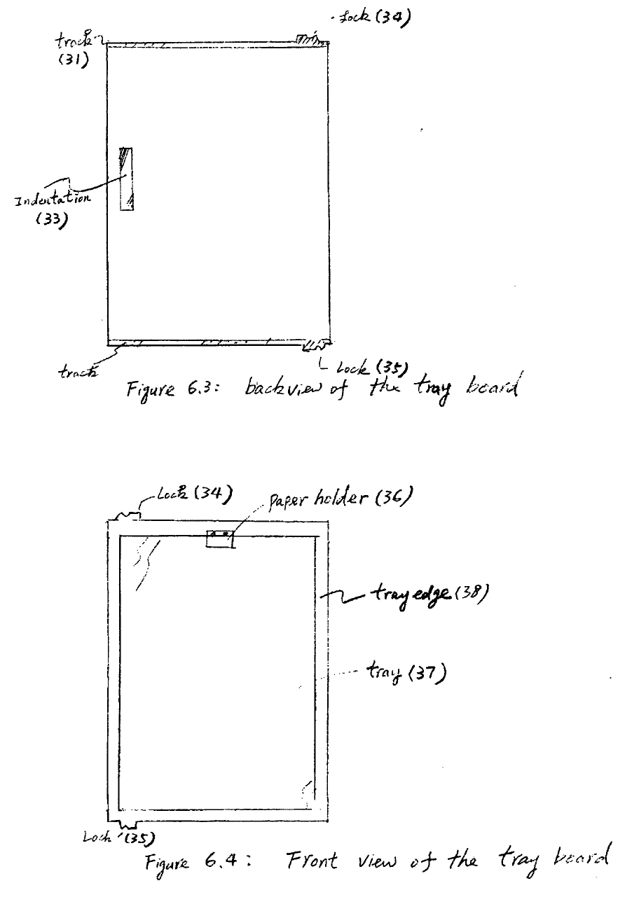

The clipboard with a sliding tray consists of two major boards: the primary board which the clip is also attached to, and a sliding board that is the one to be slid out. The tray board is held together with the Primary Board by two track strips, one on the top close to the clip and the other on the bottom. Additionally, the Track Strips allow the Tray Board to slide out. These two Track Strips are not visible in the top views, shown in FIGS. 4.1 to 4.4. Neither are they visible in side views, shown in FIGS. 5.1 to 5.2. They can only been seen from back views.

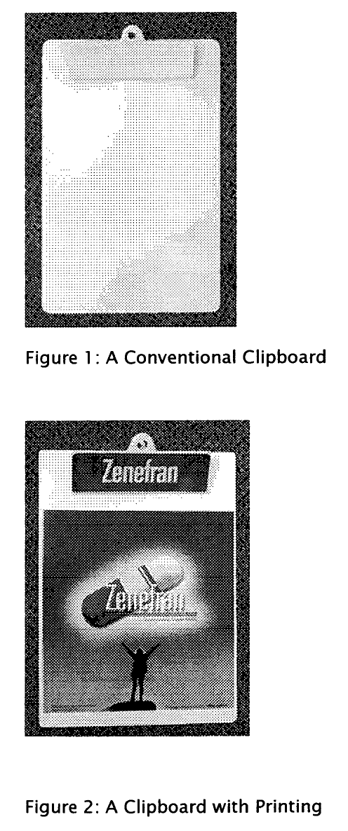

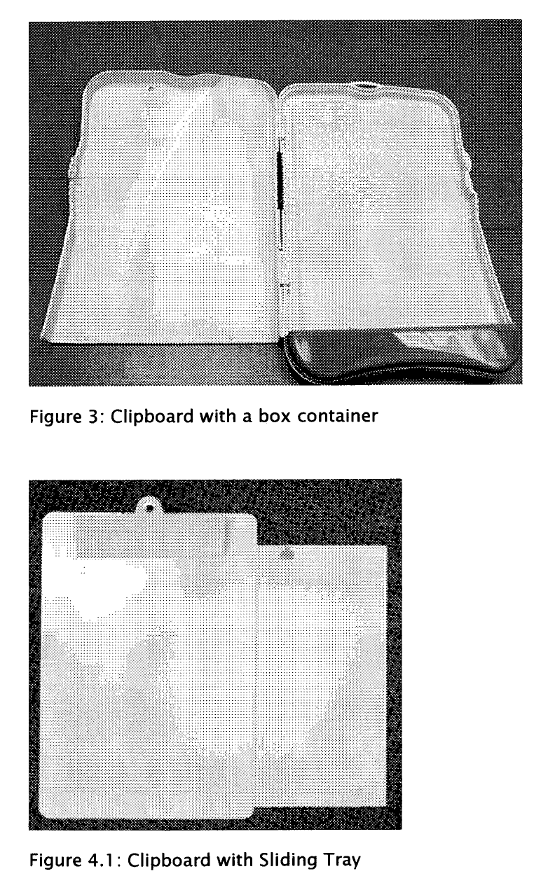

From the side views in FIGS. 5.1 to FIG. 5.2, we can see the Clip, the Primary Board, and the sliding board, as we view the board from the right side of the clipboard. Otherwise, when viewing from the top view and other side views, not from the right, we can hardly notice that the clipboard has a tray at all. In fact, FIG. 1 shown before is the top view of the Clipboard with a thin tray. Unless we point it out, people usually take that as a conventional board. FIGS. 5.3 & 5.4 show the invention's back views with the tray closed, to illustrate this point too.

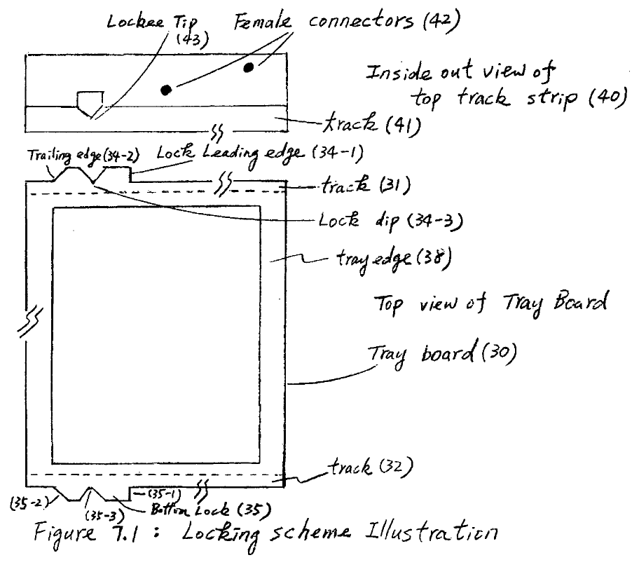

FIG. 6.1 shows the back view of the clipboard. We can see the Clip (10), the Primary Board (20), the slide Tray Board (30), the Top Track Strip (40), and the Bottom Track Strip (50). The numbering convention in the figures is as follows:
Clip (10)
Primary board (20), and all the numbers from 21 to 29, if used, are used to illustrate a part of the primary board
Sliding board (30), 31 to 39, if used, designate part of the sliding board.
Top Track Strip (40), and the numbers 40 to 49 are used or reserved for the Top Track Strip.
Similarly, 50 to 59 are for the Bottom Track Strip.

In FIG. 6.2, the back view of the primary board is shown. On the back of the board, there are 4-side of walls (21-25, clockwise) to contain the Tray Board. 3 sides (22, 23, and 24) are complete walls that accommodate the Sliding Board.

The fourth side has two short walls (21 and 25), also called the Tray Stoppers. Between the Tray Stoppers is the space for the Sliding Tray to slide out. If we view the clipboard from the tray opening side, you will see two boards, both the Primary Board and the Tray Board. On the other, you will see the Primary Board only when the tray is closed, its walls (22-24)) wrap around the Tray Board and Track Strips, see FIG. 5.4.

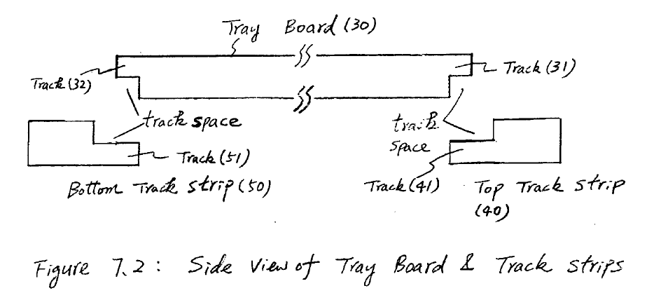

The male connectors (26, 27) are used to tie with the Top (with 26) and Bottom (with 27) Track Strips. These two strips serve the same function—holding the Primary and the Tray boards together, while enabling the Tray Board to be either in a locked position (completely closed) or various open positions as it slides out along the tracks. The Track Strips have female connectors (52 shown in FIG. 6.1 & 42 in FIG. 7.1) used to connect with the male connectors of the Primary Board. These two Strips also have one track each to enable the Sliding Board to slide along. The bottom of FIG. 6.2 shows the inside out view of the Bottom Track Strip.

FIG. 6.3 is the back view of the Sliding Tray (30), its tracks (31 and 32) slide along the tracks of the Top Track Strip (41), and the Bottom Track Strip (51). The middle left side of the Sliding Tray has an Indentation (33) to facilitate the user to slide open the tray. Note that this figure is the back view. When a user holds the clipboard, the indentation (33) is on the middle right side of the back, the sliding tray is pulled out to the right side.

The locks (34, 35) are used to limit the movement of the Sliding Board. The locking scheme when the Sliding Board is all contained in the Primary Board will be explained later. When the Sliding Board (tray) is slid out completely, the locks (34, and 35) will be stopped by the Tray Stoppers (21, 25) of the Primary Board. Specifically, the leading edges (34-1, 35-1) of the Locks, to be shown in FIG. 7.1, on the Tray Board are held back by Tray Stoppers (21, 25) of the Primary Board.

FIG. 6.4 is the front view of the Tray Board. On this board, the tray edges (38) along the peripherals are higher than the rest of the tray (37), where the paper is held. The Paper Holder (36) helps securely hold a few pages of paper in the tray, as having been demonstrated in FIGS. 4.3 & 4.4. When this board is turned to the reverse side, as shown in FIG. 6.3, the locks appear on the different side of the board. Think the mirror effect when to turn one board to the reverse side, the Primary Board shown in FIG. 6.2 is the back view. When in use, the Primary Board is facing upward, and the Tray Stoppers are on the right side.

FIG. 7.1 illustrates the locking scheme, when the sliding board is all the way in. This scheme is accomplished by the Lockee (43) in the inside-out view of the Top Track Strip (40) in this figure, and the Locks (34,35). The Lockee (43) on the Top Track Strip (40) is soft and flexible. When the Tray Board is slid in, close to the end, the trailing edges of the Locks (34-2, 35-2), will touch the Lockees (43 in the Top Track Strip shown in the figure, and 53 in the Bottom Track Strip not shown but performs similarly). When the Tray Board is pushed all the way in, the Lockee Tip (43-1) touches the Lock Dip (34-3). In a similar fashion, the Bottom Track Strip's Lockee Tip (53, not shown) touches the Bottom Lock Lock Dip (35-3). In this figure (7.1), the tracks (31 & 32) are shown in dotted lines, since they are on the back of the top tray edge and the bottom tray edge of the Tray Board, and can only be seen from the back, not from this top view.

When the Tray Board slides in and out, its tracks touch the tracks of Track Strips, as shown in FIG. 7.2. It is important to notice the track space of the Track Strips is wider than the tracks (31, 32) of the Tray Board, since the Track Strips have to accommodate the Locks (34 and 35) attached to the tracks of the Tray Board. This is because that both the locks and the tracks of the Tray Board slide through the track space of the Track Strips.

In summary, the invention is a clip board with a sliding tray. In addition to holding a pad of paper or documents via the clip on the top of the board, when the tray also holds other paper. This pad or documents secured is visible to people near-by. The present invention is a clipboard has a thin tray, holding a few other pages of paper put in by the clipboard user, who is the only one knows the content of the paper kept in the tray and decides whether and when to be shared with others.

Although the present invention having been described, is made of opaque material. It should be understood that the material can be changed to transparent as well, specially the Primary board and/or the Tray. If so, the invention is used to display often changed information, by inserting different pages in the tray.

What is claimed is:

1. The clipboard with a thin sliding tray apparatus is comprising: Clip, Primary Board, Tray Board, Top Track Strip and Bottom Track Strip, with the tray holding additional paper, which can not be seen from outside, unless the board is pulled out or the board is made of transparent material.

2. The clipboard assembly of claim 1 looks like one board when the tray is closed, from the top view and all side views, except the right side, from which only cautious observers will notice it has two boards.

3. The clipboard assembly of claim 1 is as handy as a conventional board to carry around, with the tray holding a few pages of paper, either for the privacy or for achieving a certain surprise effect when the tray board is pulling out. The handiness is accomplished through the size (thinness), the locking schemes (when the tray is closed or open, while holding paper securely), and its appearance.

4. A method for providing a clipboard apparatus of assembling the tray with the Primary Board. As the tray is pushed all the way in, a locking scheme that will lock the Tray Board with the Primary Board. Specifically, the locking scheme holds the Tray Board in the Primary Board, even when the whole board is held 90 degree to the ground. When locked, the lockee tips of the Track Strips are kept together by the lock dips of the Tray Board, while the Track Strips tie both the Primary Board (through male and female connectors), and the Tray board (tracks). As such, the whole board, even it includes two boards, functions as one.

5. The method of claim 4 further including a paper holder in the tray to hold paper securely inside the tray.

6. The method of claim 4 provides a way of pulling the tray out easily with the indentation and the tracking scheme—when the sliding board is pulled out, the indentation on the board makes the pulling movement easier for the user, while the tracks contain and guide the movement of the Tray Board related to the Primary Board.

7. When the board (or a portion of the board) is made of transparent material, the clipboard can be used to display information that needs to be changed often, while the clipboard provides a protection container for the paper kept inside the tray.
